(19) United States
(12) Patent Application Publication
(10) Pub. No.: US 2014/0288908 A1
(43) Pub. Date: Sep. 25, 2014

(54) METHODS, SYSTEMS AND COMPUTER-READABLE MEDIA FOR DETERMINING A TIME-TO FAILURE OF AN ASSET

(71) Applicant: Infosys Limited, Bangalore (IN)

(72) Inventors: HARI MANASSERY KODUVELY, MARATHAHALLI (IN); GOPICHAND AGNIHOTRAM, ANDHRA PRADESH (IN); SANDEEP KUMAR DEWANGAN, BANGALORE (IN); PREETI PISUPATI, BANGALORE (IN)

(73) Assignee: Infosys Limited, Bangalore (IN)

(21) Appl. No.: 14/214,055

(22) Filed: Mar. 14, 2014

(30) Foreign Application Priority Data
Mar. 20, 2013 (IN) 1204/CHE/2013

(51) Int. Cl. G06F 17/50

(52) U.S. Cl. CPC G06F 17/5009; G05B 15/02
USPC 703/7

(57) ABSTRACT

The present invention provides a method and system for determining a time-to-failure of an asset. A probabilistic non-linear model of a limit state of the asset is simulated and approximated by a predetermined set of particles. A numerical scheme for computation of a conditional probability distribution of a size of the defect, based on a value of the limit state is evaluated. A set of future values of a weight factor of each particle is predicted based on an initial assigned value. The predicted set of future values can be updated on capturing a new set of inspection data. A probability of the time-failure of the asset is estimated by summing the weight factor of a set of particles, the set of particles comprising particles at which the limit state is less than a zero limit threshold.

### RELATED APPLICATION DATA

This application claims priority to India Patent Application No. 1204/CHE/2013, filed Mar. 20, 2013, the disclosure of which is hereby incorporated by reference in its entirety.

### FIELD OF THE INVENTION

The present invention relates generally to a method and system for determining a life span of a mechanical asset. More specifically, the present invention relates to a method and system for determining a time-to-failure of pipeline assets.

### BACKGROUND

A probability of failure of an asset such as a pipeline is usually dependent on a set of defect growth models of defects, resulting from wear and tear of the asset. To estimate parameters of the defect growth models of the pipeline such as a growth speed, a set of high quality inspection data is required to be collected from Pipeline Inspection Gauges at regular intervals of time. Acquiring such high quality inspection data at regular intervals of time tends to be a very expensive process. Existing methods for estimating the time-to-failure of the asset provide a probability of failure of the pipeline asset. The probability of failure needs to be estimated for several years, and extrapolated into the future for getting an estimate of the remaining life span of the asset. Further, the existing methods suffer from inaccuracy in estimating the time-to-failure from such probability of failure functions. Hence an alternative method is required for providing the estimate of the remaining life time of the asset directly and accurately.

Hence there is a need for an alternative method and a system that can provide the remaining life time or the time-to-failure of the asset directly in a cost effective manner. The alternate method must utilize the partial inspection data for estimating the remaining life time of the asset directly. Thus a method for estimating a time-to-failure or the remaining life time of an asset directly is proposed.

### SUMMARY

The present invention provides a method and system for determining a time-to-failure of an asset. In accordance with a disclosed embodiment, the method may include capturing a set of inspection data of a defect of the asset, simulating a probabilistic non-linear model, whereby the probabilistic non-linear model evaluates evolution of a limit state of the asset and evaluating a numerical scheme for computation of a conditional probability distribution of a size of the defect, where the conditional probability of the size of the defect is based on a value of the limit state. Further probability distribution of the limit state can be approximated by a predetermined set of particles where each particle is associated with a weight factor. An initial value to the weight factor of the each particle is assigned, and a set of future values of the weight factor of the each particle is predicted based on the initial value. The predicted future value of the weight factor of the each particle is updated when a new set of inspection data is captured, and a probability of the time-to-failure is estimated by summing the weights factor of a set of particles, the set of particles comprising particles at which the limit state is less than a zero limit threshold.

In an additional embodiment, a system for determining a time-to-failure of an asset is disclosed. The system comprises an input module configured to capture a set of inspection data of a defect of the asset, a simulating module configured to simulate a probabilistic non-linear model, whereby the probabilistic non-linear model evaluates evolution of a limit state of the asset. The simulating module is further configured to evaluate a numerical scheme for computation of a conditional probability distribution of a size of the defect, whereby the conditional probability of the size of the defect is based on a value of the limit state. The sampling module is configured to approximate a probability distribution of the limit state by a predetermined set of particles whereby each particle is associated with a weight factor. An initializing module is configured to assign an initial value to the weight factor of the each particle. A predicting module is configured to predict a set of future values of the weight factor of the each particle, based on the initial value, and an updating module is configured to update a predicted future value of the weight factor of the each particle when a new set of inspection data is captured. Finally an estimating module configured to estimate a probability of the time-to-failure by summing the weights factors of a set of particles, the set of particles comprising particles at which the limit state is less than a zero limit threshold.

These and other features, aspects, and advantages of the present invention will be better understood with reference to the following description and claims.

### BRIEF DESCRIPTION OF THE DRAWINGS

FIG. 1 is a flowchart illustrating an embodiment of a method of determining a time-to-failure to an asset.

FIG. 2 is a flowchart illustrating a preferred embodiment of a method of determining a time-to-failure to an asset.

FIG. 3 shows an exemplary system for determining a time-to-failure to an asset.

FIG. 4 illustrates a generalized example of a computing environment 400.

While systems and methods are described herein by way of example and embodiments, those skilled in the art recognize that systems and methods for electronic financial transfers are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-program products for determining a time-to-failure of an asset. More specifically the methods, and systems disclosed provide a framework for estimating the time-to-failure of pipelines, from high quality inspection data captured from Pipeline Inspection Gauges (PIG). The time-to-failure or life time of an asset is a more useful parameter while planning and optimizing maintenance schedules of the pipelines. The methods disclosed herein, incorporate a Sequential Monte Carlo method, alternatively known as a Particle Filtering Method, for simulating a limit state equation of the asset and thereby computing a time to failure of the asset. Current inspection data of the asset is utilized for correcting a prediction made in an earlier step of the particle filtering method.

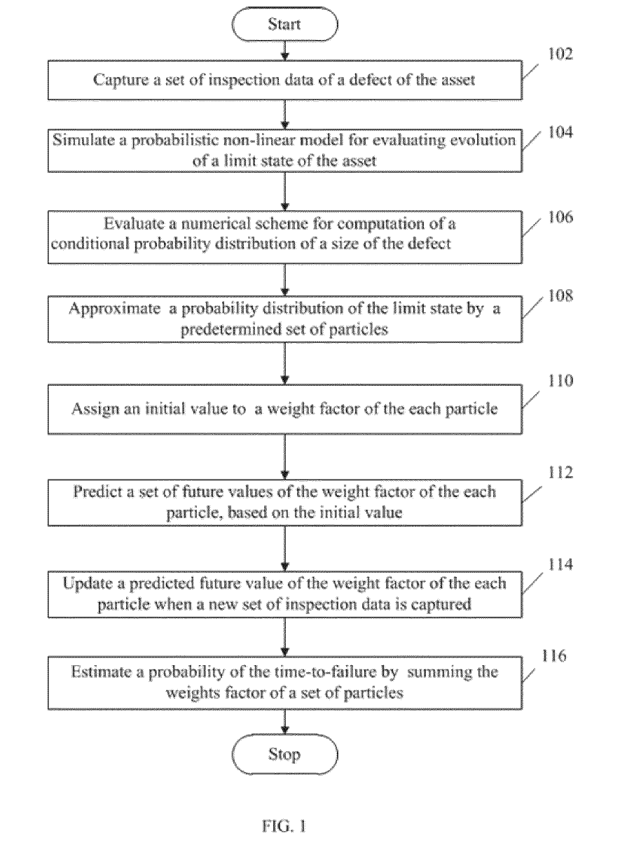

FIG. 1 is a flowchart that illustrates a method performed in determining a time-to-failure of an asset in accordance with an embodiment of the present invention. A set of inspection data of a defect of an asset can be captured at an instant of time at step 102. The set of inspection data usually includes high quality inspection data, captured by Pipeline Inspection Gauges (PIG). Alternatively the set of inspection data may include data as captured by sensor devices, at pre-determined intervals of time. In the disclosed embodiment, the defect can be a crack, a fissure of the asset, the asset being a pipeline. At step 104, a probabilistic non-linear model can be simulated, where the probabilistic non-linear model evaluates evolution of a limit state of the asset. The probabilistic non-linear model can be one of a mechanical engineering model for failure such as an American Society of Mechanical Engineering (ASME) B 31 G standard model. The limit state is usually a highly non-linear function of a plurality of features characterizing the asset such as a defect size, an elastic strength of the asset, and dimensions of the asset. In the disclosed embodiment, where the asset is the pipeline, an instance of the limit state equation may be given as follows:

$$g ( t ) = P \frac{( 1 - {C}_{1} R ( t ) )}{( 1 - \frac{{C}_{2} R ( t )}{M ( t )} )} + {ɛ}_{1} - MAOP \\ where , \\ R ( t ) = \frac{d ( t )}{T} \\ M ( t ) = \sqrt{1 + {A ( t )}^{2}} \\ A ( t ) = {C}_{2} \frac{l ( t )}{\sqrt{DT}} \\ P = \frac{2 {C}_{3} ST}{D} \qquad ( 1 )$$

MAOP=Maximum Allowable Operable Pressure of the asset. In the above equation, l (t), and d (t) are time-dependent variables, and represent length and depth of the defect respectively. The time-dependent variables, l (t) and d (t) are usually characterized by defect growth models that are random in nature. Further, a set of parameters D, T and S, represent a diameter, a thickness, and an elastic strength of the pipeline. C1, C2, C3 are certain constants, while ε1 represents a noise factor. The set of parameters appearing in the limit state equation g(t), are random functions of time, as a result a value of g(t) is also a random function of time. In a reliability theory framework, failure of a system usually occurs when the limit state equation g(t) becomes less than zero. Alternatively Probability of Failure (PoF) at any given time t, is defined as P(g(t)<0), and Time to Failure (TtF) is defined as TtF=min(t|g(t)<0). As g(t) is a random function of time, TtF shall also have a random distribution.

Further at step 106, a numerical scheme for computation of a conditional probability distribution of a size of the defect can be evaluated, where the conditional probability of the size of the defect is based on a value of the limit state. For instance, let the defect size be represented by x(t), a value of x(t) at time t, can be predicted by a value from a previous time step x(t−1), by a Markov process equation:

p(x(t)|y(1:t−1))=∫p(x(t)|x(t−1)p(x(t−1)|y(1:t−1)),

where x(t) represent the defect size, y(t) represents the limit state equation g(t), and p (x(t−1)|y(1: t−1)) is a conditional probability of the defect size at a time t−1 given a value of the limit state equation y(1: t−1), at time t−1.

Next, at step 108, the limit state equation y(t), shall be approximated by a predetermined set of particles. The approximation shall be represented as

$$p ( x ( t ) \vert y ( 1 \text{:} t ) ) \approx {\sum }_{i = 1}^{N} {w}^{i} ( t ) ,$$

where wⁱ(t) is the weight factor of the i^{th} particle.

At step 110 an initial value to a weight factor of the each particle is assigned. The weight factor shall be a time dependent factor for each particle. At step 112, a set of future values of the weight factor of the each particle shall be predicted, based on the initial value. Further at step 114, the predicted future value of the weight factor of the each particle shall be updated, when a new set of inspection data is captured. The predicted future value of the weight factor shall be updated by the following equation:

$$w ( t ) = w ( t - 1 ) \frac{p ( y ( t ) \vert x ( t ) ) p ( x ( t ) \vert x ( t - 1 ) )}{q ( x ( t ) \vert x ( 0 \text{:} t - 1 ) y ( 1 \text{:} t ) )} ,$$

where w(t) is the predicted future value of the weight factor at time t, and w(t−1) is the initial value of the weight factor. Finally at step 114, a probability of the time-to-failure can be estimated by summing the weights factor of a set of particles, by the following equation:

$${p}_{TtF} ( t ) = {\sum }_{i = 1}^{N} δ ( {x}^{i} ( t ) < 0 ) {w}^{i} ( t ) ,$$

where i=1 to N, represent the set of particles, for which the limit state equation falls below a zero limit threshold.

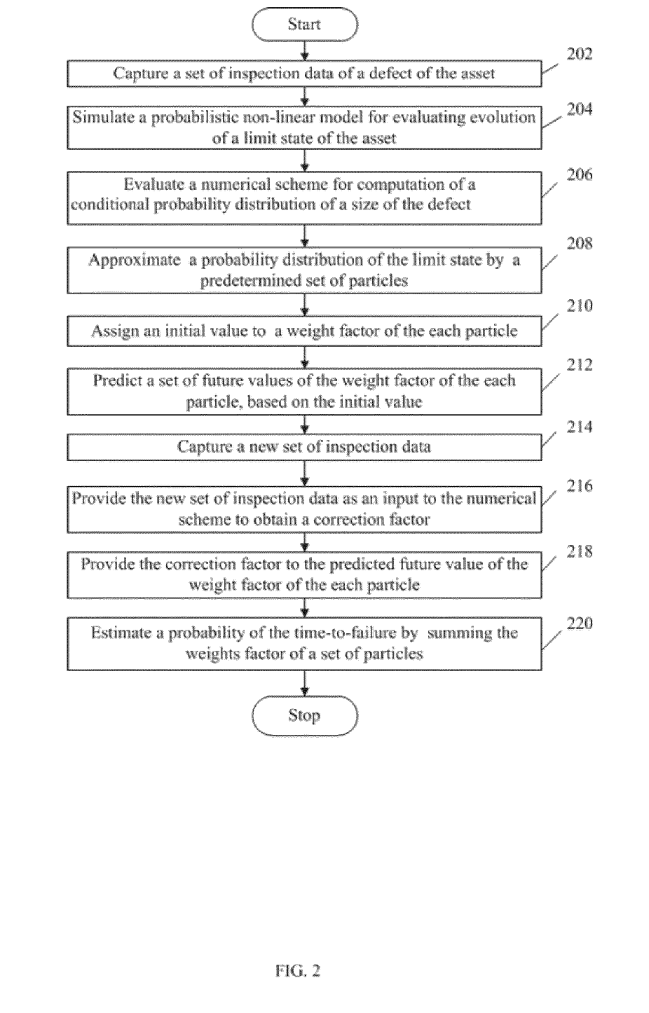

FIG. 2 illustrates an alternate embodiment of a method of practicing the present invention. A set of inspection data of a defect of an asset can be captured at an instant of time at step 202. The set of inspection data usually includes high quality inspection data, captured by Pipeline Inspection Gauges (PIG). Alternatively the set of inspection data may include data as captured by sensor devices, at pre-determined intervals of time. At step 204, a probabilistic non-linear model can be simulated, where the probabilistic non-linear model evaluates evolution of a limit state of the asset. The limit state is usually a highly non-linear function of a plurality of features characterizing the asset such as a defect size, an elastic strength of the asset, and dimensions of the asset. In the disclosed embodiment, where the asset is the pipeline, an instance of the limit state equation may be given as follows:

$$g ( t ) = P \frac{( 1 - {C}_{1} R ( t ) )}{( 1 - \frac{{C}_{2} R ( t )}{M ( t )} )} + {ɛ}_{1} - MAOP \\ where , \\ R ( t ) = \frac{d ( t )}{T} \\ M ( t ) = \sqrt{1 + {A ( t )}^{2}} \\ A ( t ) = {C}_{2} \frac{l ( t )}{\sqrt{DT}} \\ P = \frac{2 {C}_{3} ST}{D} \qquad ( 1 )$$

MAOP=Maximum Allowable Operable Pressure of the asset. In the above equation, parameters l (t), and d (t) are time-dependent variables, and represent length and depth of the defect respectively. The parameters l (t) and d (t) are usually characterized by defect growth models that are random in nature. Further, parameters D, T and S, represent a diameter, a thickness, and an elastic strength of the pipeline. C1, C2, C3 are certain constants, while ε₁ represents a noise factor. Due to random nature of the parameters appearing in the limit state equation g(t), a value of g(t) also takes a random nature. In a reliability theory framework, failure of a system usually occurs when the limit state equation g(t) becomes less than zero. Alternatively Probability of Failure (PoF) at any given time t, is defined as P(g(t)<0), and Time to Failure (TtF) is defined as TtF=min(t|g(t)<0). As g(t) is a random function of time, TtF shall also have a random distribution.

Further at step 206, a numerical scheme for computation of a conditional probability distribution of a size of the defect can be evaluated, where the conditional probability of the size of the defect is based on a value of the limit state. For instance, let the defect size be represented by x(t), a value of x(t) at time t, can be predicted by a value from a previous time step x(t−1), by a Markov process equation:

p(x(t)|y(1:t−1))=∫p(x(t)|x(t−1))p(x(t−1)|y(1:t−1)),

where x(t) represent the defect size, y(t) represents the limit state equation g(t), and p(x(t−1)|y(1: t−1)) is a conditional probability of the defect size at a time t−1 given a value of the limit state equation y(1: t−1), at time t−1.

Next, at step 208, the limit state equation y(t), shall be approximated by a predetermined set of particles. The approximation shall be represented as

$$p ( x ( t ) \vert y ( 1 \text{:} t ) ) \approx {\sum }_{i = 1}^{N} {w}^{i} ( t ) ,$$

where wⁱ(t) is the weight factor of the i^{th} particle.

At step 210 an initial value to a weight factor of the each particle is assigned. The weight factor shall be a time dependent factor for each particle. At step 212, a set of future values of the weight factor of the each particle shall be predicted, based on the initial value. Further at step 214, a new set of inspection data can be captured. At step 216, the new set of inspection data is provided as an input to the numerical scheme to obtain a correction factor to be applied for the predicted set of future values. At step 218, the correction factor can be applied to the predicted set of future values for updating the predicted values. The correction factor so applied to the future value of the weight factor shall be applied by the following equation:

$$w ( t ) = w ( t - 1 ) \frac{p ( y ( t ) \vert x ( t ) ) p ( x ( t ) \vert x ( t - 1 ) )}{q ( x ( t ) \vert x ( 0 \text{:} t - 1 ) y ( 1 \text{:} t ) )} ,$$

where w(t) is the predicted future value of the weight factor at time t, and w(t−1) is the initial value of the weight factor. Finally at step 220, a probability of the time-to-failure can be estimated by summing the weights factor of a set of particles, by the following equation:

$${p}_{TtF} ( t ) = {\sum }_{i = 1}^{N} δ ( {x}^{i} ( t ) < 0 ) {w}^{i} ( t ) ,$$

where i=1 to N, represent the set of particles, for which the limit state equation falls below a zero limit threshold.

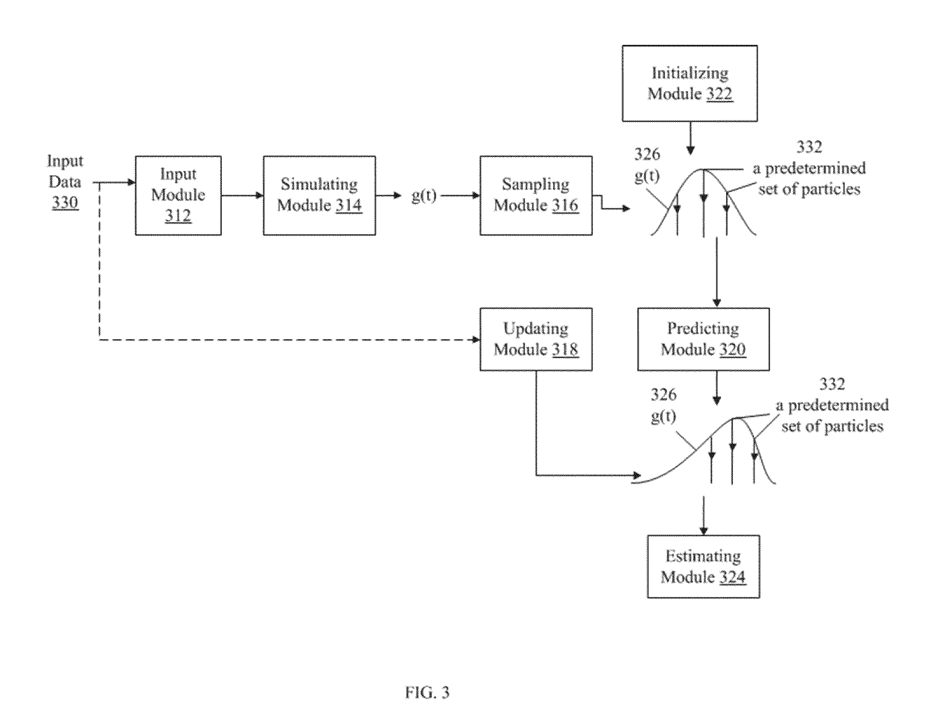

FIG. 3 illustrates an exemplary system 300 in which various embodiments of the invention can be practiced. The exemplary system 300 includes an input module 312, a simulating module 314, a sampling module 316, an initializing module 322, an updating module 318, a predicting module 320, and an estimating module 324. Input data 330 represent a set of inspection data of a defect of an asset, captured by the input module 312. The set of inspection data usually includes high quality inspection data, captured by Pipeline Inspection Gauges (PIG). Alternatively the set of inspection data may include data as captured by sensor devices, at predetermined intervals of time. The simulating module 314 is configured to simulate a probabilistic non-linear model, the probabilistic non-linear model configured to evaluate evolution of a limit state, g(t), of the asset. Further, the simulating module 314, is also configured to evaluate a numerical scheme for computation of a conditional probability distribution of a size of the defect, whereby the conditional probability of the size of the defect is based on a value of the limit state, g(t). The sampling module 316 is configured to approximate a probability distribution of the limit state, g (t) by a predetermined set of particles 332, whereby each particle is associated with a weight factor. The initializing module 322 can be configured to assign an initial value to the weight factor of the each particle. The predicting module 320 can be configured to predict a set of future values of the weight factor of the each particle, based on the initial value, and the updating module 318, can be configured to update a predicted future value of the weight factor of the each particle when a new set of inspection data is captured. The estimating module 324, can be configured to estimate a probability of the time-to-failure by summing the weights factors of a set of particles, the set of particles comprising particles at which the limit state, g (t), is less than a zero limit threshold.

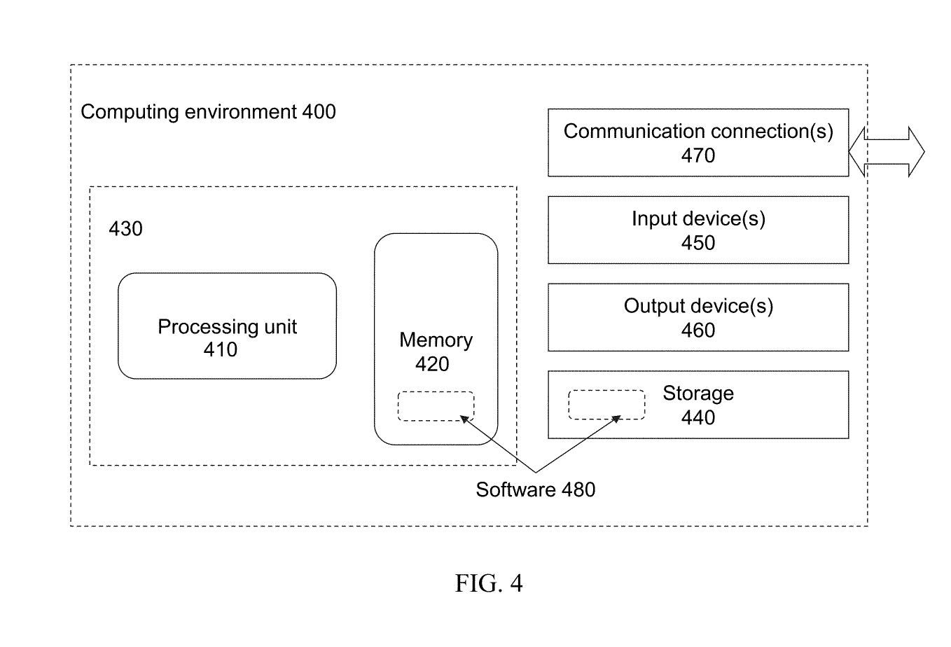

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 440, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method for determining a time-to-failure of an asset, the method comprising:
capturing a set of inspection data of a defect of the asset;
simulating a probabilistic non-linear model, whereby the probabilistic non-linear model evaluates an evolution of a limit state of the asset;
evaluating a numerical scheme for computation of a conditional probability distribution of a size of the defect, whereby the conditional probability of the size of the defect is based on a value of the limit state;
approximating a probability distribution of the limit state by a predetermined set of particles whereby each particle is associated with a weight factor;
assigning an initial value to the weight factor of the each particle;
predicting a set of future values of the weight factor of the each particle, based on the initial value;
updating a predicted future value of the weight factor of the each particle when a new set of inspection data is captured; and
estimating a probability of the time-to-failure by summing the weights factors of a set of particles, the set of particles comprising particles at which the limit state is less than a zero limit threshold.

2. The method of claim 1, wherein the probabilistic non-linear model is based on a set of parameters and the set of inspection data.

3. The method of claim 1, wherein the set of inspection data comprises one or more dimensions of the defect.

4. The method of claim 2, wherein the set of parameters of the asset, include a diameter, a thickness and an elastic strength of a cross-section of the asset at a location of the defect, a noise term, and a maximum allowable operable pressure of the asset.

5. The method of claim 3, wherein the one or more dimensions of the defect include a length of the defect and a depth of the defect.

6. The method of claim 2, wherein the set of inspection data of the defect and the set of parameters of the asset are random functions of time.

7. The method of claim 1, wherein the weight factor is time dependent.

8. The method of claim 1, wherein a value of the limit state of the asset at a current time is based on a value of the limit state at a previous time.

9. The method of claim 1, whereby the set of future values of the weight factor of the each particle is dependent iteratively on a previous value and a current value of the each particle.

10. The method of claim 1, wherein the step of updating further comprises;
providing a correction factor to the predicted future value of the weight factor of the each particle, whereby the correction factor is obtained on providing the new set of inspection data as an input to the numerical scheme.

11. A system for determining a time-to-failure of an asset, the system comprising:
an input module configured to capture a set of inspection data of a defect of the asset;
a simulating module configured to:
simulate a probabilistic non-linear model, whereby the probabilistic non-linear model evaluates an evolution of a limit state of the asset; and
evaluate a numerical scheme for computation of a conditional probability distribution of a size of the defect, whereby the conditional probability of the size of the defect is based on a value of the limit state;
a sampling module configured to approximate a probability distribution of the limit state by a predetermined set of particles whereby each particle is associated with a weight factor;
an initializing module configured to assign an initial value to the weight factor of the each particle;
a predicting module configured to predict a set of future values of the weight factor of the each particle, based on the initial value;
an updating module configured to update a predicted future value of the weight factor of the each particle when a new set of inspection data is captured; and
an estimating module configured to estimate a probability of the time-to-failure by summing the weights factors of a set of particles, the set of particles comprising particles at which the limit state is less than a zero limit threshold.

12. The system of claim 11, wherein the probabilistic non-linear model is based on a set of parameters and the set of inspection data.

13. The system of claim 11, wherein the set of inspection data comprises one or more dimensions of the defect.

14. The system of claim 12, wherein the set of parameters of the asset, include a diameter, a thickness and an elastic strength of a cross-section of the asset at a location of the defect, a noise term, and a maximum allowable operable pressure of the asset.

15. The system of claim 13, wherein the one or more dimensions of the defect include a length of the defect and a depth of the defect.

16. The system of claim 12, wherein the set of inspection data of the defect and the set of parameters of the asset are random functions of time.

17. The system of claim 11, wherein the weight factor is time dependent.

18. The system of claim 11, wherein a value of the limit state of the asset at a current time is based on a value of the limit state at a previous time.

19. The system of claim 11, whereby the set of future values of the weight factor of the each particle is dependent iteratively on a previous value and a current value of the each particle.

20. The system of claim 11, wherein the step of updating further comprises:
providing a correction factor to the predicted future value of the weight factor of the each particle, whereby the correction factor is obtained on providing the new set of inspection data as an input to the numerical scheme.

21. A computer program product consisting of a plurality of program instructions stored on a non-transitory computer-readable medium that, when executed by a computing device, performs a method for determining a time-to-failure of an asset, the method comprising capturing a set of inspection data of a defect of the asset;
simulating a probabilistic non-linear model, whereby the probabilistic non-linear model evaluates an evolution of a limit state of the asset;
evaluating a numerical scheme for computation of a conditional probability distribution of a size of the defect, whereby the conditional probability of the size of the defect is based on a value of the limit state
approximating a probability distribution of the limit state by a predetermined set of particles whereby each particle is associated with a weight factor;
assigning an initial value to the weight factor of the each particle;
predicting a set of future values of the weight factor of the each particle, based on the initial value
updating a predicted future value of the weight factor of the each particle when a new set of inspection data is captured; and
estimating a probability of the time-to-failure by summing the weights factors of a set of particles, the set of particles comprising particles at which the limit state is less than a zero limit threshold.
